(19) United States
(12) Patent Application Publication
(10) Pub. No.: US 2013/0320947 A1
(43) Pub. Date: Dec. 5, 2013

(54) SYSTEM AND METHOD FOR SUPPLYING POWER

(71) Applicant: Samsung Electro-Mechanics Co., Ltd., Gyeonggi-do (KR)

(72) Inventors: Young Seung Noh, Gyeonggi-do (KR); Bo Mi Lee, Gyeonggi-do (KR); Sung Nam Ko, Gyeonggi-do (KR)

(21) Appl. No.: 13/906,269

(22) Filed: May 30, 2013

(30) Foreign Application Priority Data
May 31, 2012 (KR) 10-2012-0058288

(51) Int. Cl. G05F 1/10

(52) U.S. Cl. CPC G05F 1/10
USPC 323/283; 323/285

(57) ABSTRACT

The present invention relates to a system for supplying power and a method for supplying power using the same. In a system for supplying power including a load device and a power device for supplying power to the load device, the power device includes an output control unit and a power circuit for outputting power with required voltage and current of the load device, and the load device includes an input control unit and a load for receiving the power from the power circuit.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2012-0058288, entitled filed May 31, 2012, which is hereby incorporated by reference in its entirety into this application.”

### BACKGROUND OF THE INVENTION

1. Field of the Invention

The present invention relates to a system and a method for supplying power, and more particularly, to a system and a method for supplying power that can be applied to a plurality of load devices.

2. Description of the Related Art

In recent times, the trends in portable electronic devices are systemization, digitalization, wireless, multimedia, intelligent, complexing, and so on. Among them, as the social interest in the multimedia increases, small and portable multimedia is in the spotlight. Especially, in recent times, as mobile devices including a smartphone and a tablet PC are getting the spotlight as new information devices, there is an increasing new mechanical requirement for a power supply system for charging batteries of these apparatuses, for example, an AC/DC adapter.

In a conventional adapter, there are only official regulations on standby power, but as several functions including a touch screen are added to the mobile devices, the influence on a main body should be minimized while the adapter charges the device. And, on the other hand, there is an increasing demand for studies on the power supply system consisting of one adapter, which can be applied to a plurality of mobile devices with different driving voltages.

That is, since the rated power specifications as well as the kind of mobile devices are various, a dedicated adapter is needed for each device. Accordingly, in addition to price problems, consumers should suffer inconvenience of preparing the adapters as many as the kind of mobile devices.

In order to overcome these problems, when sharing an input voltage of the mobile device, for example, as 5V, the devices requiring high power such as a notebook PC need more current. Due to this, since a separate heat-radiating apparatus for absorbing heat generated from the device is needed, the volume of products is increased and prices rise.

On the contrary to this, when increasing the input voltage, for example, to 12V, in case of the devices requiring low power such as a smartphone, an element with a withstand voltage as high as a rising range of the input voltage should be used. However, since the element with a high withstand voltage generally has a large size and high cost, it is difficult to achieve miniaturization of the products and price competitiveness may be deteriorated.

In relation to this, in Japanese Patent Laid-open Publication No. 1999-353041 (hereinafter, related art document), a connection relay unit that is detachable and has voltage information is provided. Through this, one adapter can be applied to a plurality of load devices by automatically setting an output voltage of the adapter.

However, the invention disclosed in the related art document provides each connection relay unit corresponding to each load device. Accordingly, since consumers should use the connection relay unit suitable for each load device, a power supply system that can be applied to a plurality of load devices is not substantially provided.

As another conventional method, there is a method of recognizing a load device by using impedance provided on the load device side. That is, when the load device is connected to an adapter, the adapter recognizes the load device by sensing an output voltage applied by the difference in impedance between the adapter and the load device.

This method has advantages that a common connection cable (DC power plug) can be used and installation of an additional line is not needed, but has a problem that the load device can be erroneously recognized when the impedance value is changed due to line length and contact resistance.

Further, when applied to a plurality of load devices, it is difficult to recognize the load device due to the minute difference in impedance. Due to this, expandability is deteriorated.

FIG. 1 is a schematic block diagram of a system for supplying power using a wired communication line.

Describing a system for supplying power using a wired communication line (specifically, RS-232C communication) with reference to FIG. 1, a power line PL for power supply, two data signal lines TXD and RXD for transmitting and receiving data, and a ground line GND for providing a reference potential for input and output signals are connected between a power device 10 and a load device 20.

When the power device 10 and the load device 20 are connected, information of a load circuit unit 21 including information of a load 22 is transmitted to a load information detecting unit 11 inside the power device 10 through the data signal lines TXD and RXD. The load information detecting unit 21 detects the information on the load 22 through the signal received by wire to allow a power circuit 12 to output power suitable for the load 22.

Like this, since the system for supplying power using RS-232C communication needs the two data signal lines TXD and RXD for transmitting and receiving data and the ground line GND for providing a reference potential, it cannot be implemented in an existing connection cable without installation of an additional line.

Further, a plurality of capacitors and inductors are mounted to the power device because of EMI noise, surge current, EOS, and so on. In the RS-232C communication using a high frequency for transmission of more data, these capacitor and inductor function as low pass filters to interrupt normal signal transmission. Accordingly, when implementing the RS-232C communication using over hundreds or thousands of KHz in the existing connection cable, malfunctions of the device may occur due to erroneous recognition of the information of the load device.

Meanwhile, in case of I2C communication, since it needs three lines: an SDA signal line for transmitting data, an SCL signal line for transmitting a clock signal, and a ground line for a reference potential, like the RS-232C communication, in order to use it, an additional line should be installed and information recognition errors may occur due to use of a high frequency band.

### SUMMARY OF THE INVENTION

The present invention has been invented in order to overcome the above-described problems and it is, therefore, an object of the present invention to provide a system for supplying power that can improve recognition accuracy and stability of a load device without installation of a separate line, in a system for supplying power that supplies power by recognizing a plurality of load devices through one power device, and a method for supplying power using the same.

In accordance with one aspect of the present invention to achieve the object, there is provided a system for supplying power including a load device and a power device for supplying power to the load device, wherein the power device includes an output control unit and a power circuit for outputting power with required voltage and current of the load device, and the load device includes an input control unit and a load for receiving the power from the power circuit, wherein the output control unit includes a power connection signal generating unit for converting a waveform of an output voltage signal Vo to allow the load device to recognize connection of the power device; and a load information detecting unit for detecting information of the load device through the waveform of the output voltage signal Vo converted by the input control unit, and the input control unit includes a power connection recognizing unit for recognizing the connection of the power device through the waveform of the output voltage signal Vo converted by the output control unit; and a load information signal generating unit for converting the waveform of the output voltage signal Vo to include the information of the load device.

Further, the power connection signal generating unit or the load information signal generating unit transmits the converted output voltage signal Vo through a power line PL, and the power connection recognizing unit or the load information detecting unit receives the converted output voltage signal Vo through the power line PL.

Further, the load information detecting unit outputs a control signal Vc to the power circuit to output power with required voltage and current of the load.

Further, the information of the load device includes voltage and current values required for operation of the load.

Further, the power connection signal generating unit converts the output voltage signal Vo into a square wave with a specific frequency or duty ratio for a predetermined time T1.

Further, the load information signal generating unit converts the output voltage signal Vo into a square wave with a specific frequency or duty ratio or a direct current of a specific level for a predetermined time T2.

Further, the power device further includes a switching element connected between the power circuit and an output terminal of the power device to control output power of the power circuit according to a signal of the output control unit.

Further, the output control unit outputs an off signal to the switching element for the predetermined time T1 and T2 and outputs an on signal after the predetermined time T1 and T2.

Further, the load device further includes a load recognition impedance connected between the power line PL and a ground line GND.

Further, the system for supplying power further includes a switching element provided inside the load to prevent the output voltage signal Vo converted by the power connection signal generating unit or the load information signal generating unit from being transmitted to the load.

In accordance with another aspect of the present invention to achieve the object, there is provided a system for supplying power including a load device and a power device for supplying power to the load device, wherein the power device includes a power circuit for outputting power with required voltage and current of the load device; a microcontroller unit (MCU) including a first terminal for transmitting an output voltage through a line L1 connected to a power line PL, a second terminal for outputting a signal for controlling on/off operations of a first switching element S1, and a third terminal for sensing an output voltage signal Vo through a line L2 connected to the power line L2; and the first switching element connected between the line L1 and a ground line GND to convert a waveform of the output voltage signal Vo, and the load device includes a load for receiving the power from the power circuit; a load IC including a first terminal for sensing the output voltage signal Vo through a line L3 connected to the power line PL and a second terminal for outputting a signal for controlling on/off operations of a second switching element S2; and the second switching element connected between the line L3 and the ground line GND to convert the waveform of the output voltage signal Vo.

Further, the MCU detects information of the load device according to the waveform of the output voltage signal Vo sensed through the line L2 and outputs on/off signals to the first switching element to allow the load device to recognize connection of the power device.

Further, the load IC recognizes the connection of the power device through the waveform of the output voltage signal Vo sensed through the line L3 and outputs on/off signals to the second switching element to include the information of the load device.

Further, the MCU further includes a fourth terminal for outputting a control signal Vc to the power circuit.

Further, the MCU outputs the on/off signals to the first switching element for a predetermined time T1 to convert the output voltage signal Vo, which is transmitted through the line L1, into a square wave with a specific frequency or duty ratio.

Further, in claim 11, the load IC outputs the on/off signals to the second switching element for a predetermined time T2 to convert the output voltage signal Vo, which is transmitted through the line L1, into a square wave with a specific frequency or duty ratio or a direct current of a specific level.

Further, the power device further includes a third switching element connected between the power circuit and an output terminal of the power device to control output power of the power circuit according to a signal of the MCU.

Further, the MCU further includes a fifth terminal for outputting an off signal to the third switching element for the predetermined time T1 and T2 and outputting an on signal after the predetermined time T1 and T2.

Further, the load device further includes a resistor R3 connected between the line L3 and the ground line GND.

Further, the MCU recognizes connection of the load device by sensing a drop of the output voltage through the line L3 when the output voltage, which is transmitted through the first terminal of the MCU is dropped below a certain level by the resistor R3.

Further, the MCU is implemented with a comparator for comparing the output voltage input through an inverting terminal connected to the line L2 and a reference voltage Vref input through a non-inverting terminal to recognize the connection of the load device; a pulse generator for outputting the on/off signals to the first switching element S1 according to an output signal of the comparator to convert the waveform of the output voltage signal Vo; and an OP amplifier for detecting the information of the load through a feedback signal input to the inverting terminal and the output voltage signal of a specific level input to the non-inverting terminal.

Further, the MCU is implemented with a comparator for comparing the output voltage input through an inverting terminal connected to the line L2 and a reference voltage Vref input through a non-inverting terminal to recognize the connection of the load device; a pulse generator for outputting the on/off signals to the first switching element S1 according to an output signal of the comparator to convert the waveform of the output voltage signal Vo; a counter for counting the number of pulses included in the output voltage signal Vo sensed through the line L2 for the predetermined time T2; and a digital-to-analog converter (DAC) for converting an output signal of the counter into a continuous signal that can be recognized by the power circuit.

Further, the MCU is implemented with a comparator for comparing the output voltage input through an inverting terminal connected to the line L2 and a reference voltage Vref input through a non-inverting terminal to recognize the connection of the load device; a pulse generator for outputting the on/off signals to the first switching element S1 according to an output signal of the comparator to convert the waveform of the output voltage signal Vo; a timer for measuring a duty ratio of the output voltage signal Vo sensed through the line L2 for the predetermined time T2; and a DAC for converting an output signal of the timer into a continuous signal that can be recognized by the power circuit.

In accordance with another aspect of the present invention to achieve the object, there is provided a method for supplying power using a system for supplying power including a power device consisting of a power circuit, a power connection signal generating unit, and a load information detecting unit and a load device consisting of a load, a power connection recognizing unit, and a load information signal generating unit, including: (a) recognizing connection of the load device by the power device when the load device is connected to the power device; (b) converting a waveform of an output voltage signal Vo for a predetermined time T1 by the power connection signal generating unit; (c) determining whether the power connection recognizing unit recognizes connection of the power device; (d) converting the waveform of the output voltage signal Vo for a predetermined time T2 by the load information signal generating unit; (e) detecting information of the load device through the converted output voltage signal Vo by the load information detecting unit; and (f) outputting power suitable for the load according to a control signal Vc by the power circuit.

Further, in the step (a), when the power device recognizes the connection of the load device, a switching element connected between the power circuit and the load is turned off and then turned on after the predetermined time T1 and T2.

Further, in the step (c), when it is determined that the power connection recognizing unit does not recognize the connection of the power device, the power circuit outputs initial driving power of the load device and the flow branches to the step (b).

Further, the switching element connected between the power circuit and the load is turned on before the output of the initial driving power and turned off after the output of the initial driving power.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a system for supplying power using a wired communication line;

FIG. 2 is a circuit block diagram showing a configuration of a system for supplying power in accordance with the present invention;

FIG. 3 is a timing diagram showing an output voltage signal Vo that is input and output between a power device and a load device;

FIG. 4 is an implementation circuit diagram of the system for supplying power in accordance with the present invention;

FIGS. 5 to 7 are timing diagrams of a load information signal generated for a predetermined time T2;

FIG. 8 is a detailed circuit diagram of a system for supplying power implemented in a direct current type output voltage signal Vo with a specific level;

FIG. 9 is a detailed circuit diagram of a system for supplying power implemented in a square wave type output voltage signal Vo with a specific frequency;

FIG. 10 is a detailed circuit diagram of a system for supplying power implemented in a square wave type output voltage signal Vo with a specific duty ratio; and

FIG. 11 is a flowchart of a method for supplying power in accordance with the present invention.

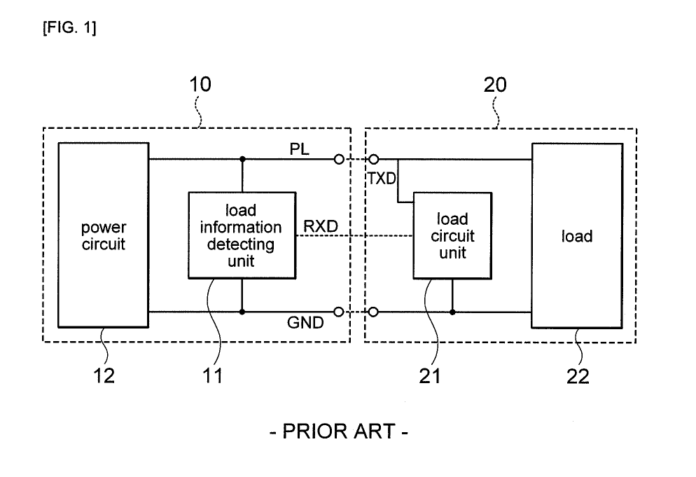

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Hereinafter, configuration and operational effect of the present invention will be described in detail with reference to the accompanying drawings.

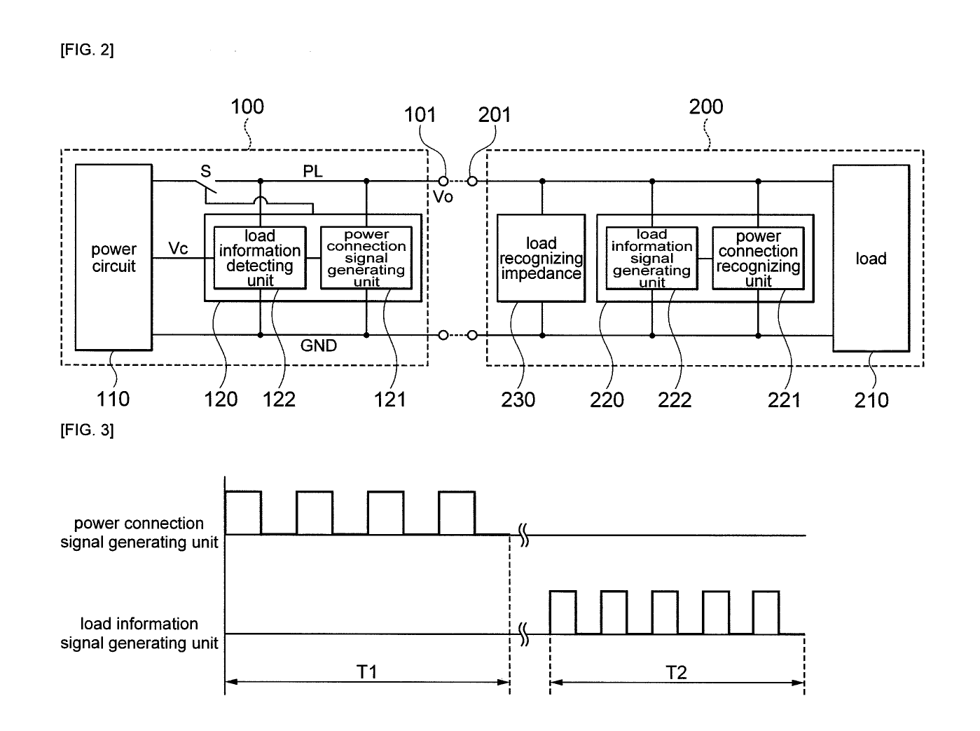

FIG. 2 is a circuit block diagram showing a configuration of a system for supplying power in accordance with the present invention.

Referring to FIG. 2, the system for supplying power in accordance with the present invention may include a power device 100, which consists of a power circuit 110 and an output control unit 120, and a load device 200, which consists of an input control unit 220 and a load 210.

In addition, the load device 200 may further include a load recognizing impedance 230 connected between a power line PL and a ground line GND, and the power device 100 may further include a switching element S connected between the power circuit 110 and an output terminal 101 of the power device 100 to control output power of the power circuit 110 according to a signal of the output control unit 120.

The power circuit 110 outputs power with required voltage and current of the load 210, and the load 210 receives the output power of the power circuit 110 through the power line PL. That is, the power circuit 110 and the load 210 are connected through the power line PL and the ground line GND to enable input and output of power.

Here, the power line PL means one line formed by connecting the output terminal 101 of the power device 100 to an input terminal 201 of the load device 200 through an existing connection cable (DC power plug).

The input control unit 220 is connected between the power line PL and the ground line GND, recognizes connection of the power device 100 through the power line PL, and outputs a signal including information of the load device 200 to the output control unit 120.

And, the output control unit 120 is also connected between the power line PL and the ground line GND, outputs a signal including connection information of the power device 100 to the input control unit 220 through the power line PL, and receives the signal output from the input control unit 220 through the power line PL to detect the information of the load device 200.

More specifically describing configurations of the output control unit 120 and the input control unit 220, first, the output control unit 120 consists of a power connection signal generating unit 121, which converts a waveform of an output voltage signal Vo to allow the load device 200 to recognize the connection of the power device 100, and a load information detecting unit 122, which detects the information of the load device 200 through the waveform of the output voltage signal Vo converted by the input control unit 220.

Here, the output voltage signal Vo, a signal of a voltage of the power output from the power circuit 110 and transmitted to the input terminal 201 through the power line PL, is a signal appearing in the output terminal 101.

The input control unit 220 consists of a power connection recognizing unit 221, which recognizes the connection of the power device 100 through the waveform of the output voltage signal Vo converted by the output control unit 120, and a load information signal generating unit 222, which converts the waveform of the output voltage signal Vo to include the information of the load device 200.

That is, the power connection signal generating unit 121 or the load information signal generating unit 222 includes information of each device through the conversion of the waveform of the output voltage signal Vo which is input and output between the power device 100 and the load device 200 through the power line PL. And, the power connection recognizing unit 221 or the load information detecting unit 122 recognizes connection of the opposite device or detects information of the opposite device according to the output voltage signal Vo transmitted through the power line PL.

FIG. 3 is a timing diagram showing the output voltage signal Vo which is input and output between the power device 100 and the load device 200, and an operation principle of the system for supplying power in accordance with the present invention will be described with reference to FIG. 3.

When the load device 200 is connected to the power device 100 for power supply, the power device 100 recognizes connection of the load device 200 by sensing a level of the output voltage signal Vo changed by the load recognizing impedance 230.

Although a conventional method identifies respective load devices by allowing the respective load devices to have different impedance, in the present invention, as described above, the load recognizing impedance 230 is used only for allowing the power device 100 to recognize the connection of the load device 200.

When the power device 100 recognizes the connection of the load device 200 through the load recognizing impedance 230, the power connection signal generating unit 121 converts the output voltage signal Vo into a square wave for a predetermined time T1 as in FIG. 3.

The square wave type output voltage signal Vo converted by the power connection signal generating unit 121 has a specific frequency or duty ratio according to a preset code. The code may be programmed to be stored in the power connection signal generating unit 121.

The output voltage signal Vo with a specific frequency or duty ratio, which is converted by the power connection signal generating unit 121, includes the connection information of the power device 100. That is, the connection information of the power device 100 is stored in a predetermined pattern, in other words, in the form of a specific frequency or duty ratio, according to the preset code.

Meanwhile, it is preferred that one cycle of the output voltage signal Vo converted into a square wave is greater than several tens of ms to prevent the signal from being distorted or smoothed by a capacitor and an inductor which essentially exist in the power device 100.

The square wave type output voltage signal Vo converted by the power connection signal generating unit 121 is transmitted to the power connection recognizing unit 221 through the power line PL, and the power connection recognizing unit 221 recognizes the connection of the power device 100 by checking whether the input square wave type output voltage signal Vo has a predetermined specific frequency or duty ratio.

When the power connection recognizing unit 221 recognizes the connection of the power device 100, the load information signal generating unit 222 converts the output voltage signal Vo into a square wave or a direct current of a specific level for a predetermined time T2 as in FIG. 3.

The square wave type output voltage signal Vo converted by the load information signal generating unit 222 has a specific level or a specific frequency or duty ratio according to the preset code. The code may be programmed to be stored in the power connection signal generating unit 121, and the information of the load device 200 is voltage and current values required for operation of the load 210.

The output voltage signal Vo of a specific level, or a specific frequency or duty ratio, which is converted by the load information signal generating unit 222, includes the information of the load device 200. That is, the information of the load device 200 is stored in a predetermined pattern, in other words, in the form of a specific frequency or duty ratio, according to the preset code.

Also at this time, it is preferred that one cycle of the output voltage signal Vo converted into a square wave is greater than several tens of ms to prevent the signal from being distorted or smoothed by a capacitor and an inductor which essentially exist in the power device 100.

The switching element S cuts off the output power of the power circuit 110 according to an off signal output from the output control unit 120 for the predetermined time T1 and T2.

The square wave type output voltage signal Vo, which is converted by the load information signal generating unit 222, is transmitted to the load information detecting unit 122 through the power line PL, and the load information detecting unit 122 detects the voltage and current values required for the operation of the load 210 according to the predetermined specific frequency or duty ratio or the specific level of direct current of the input square wave type output voltage signal Vo.

The load information detecting unit 122 outputs a control signal Vc corresponding to the detected voltage and current values to the power circuit 110, and the power circuit 110 outputs power suitable for the load 210 according to the control signal Vc. At this time, the switching element S connects the power circuit 110 and the load 210 by receiving an on signal from the output control circuit 120.

Meanwhile, in order to prevent the output voltage signal Vo converted by the power connection signal generating unit 121 or the load information signal generating unit 222 from being transmitted to the load 210, it is preferred that the level of the converted output voltage signal Vo is limited in the range of being cut off by a switching element (not shown in the drawing) provided inside the load 210. When the level of the converted output voltage signal Vo is outside the set range, the signal may be smoothed, for example, by a battery with characteristics of a large capacitor provided inside the load 210, thus causing errors in signal transmission. Therefore, the switching element (not shown) provided inside the load 210 is turned off when a signal over a certain size is input. Since this can be implemented by various commercial circuits, detailed description thereof will be omitted.

Now, a specific embodiment for implementing the above-described system for supplying power in accordance with the present invention will be described. An embodiment described below is an embodiment that implements the power connection signal generating unit 121 and the load information detecting unit 122 inside the above-described power device 100 and the power connection recognizing unit 221 and the load information signal generating unit 222 inside the load device 200 using respective dedicated controllers.

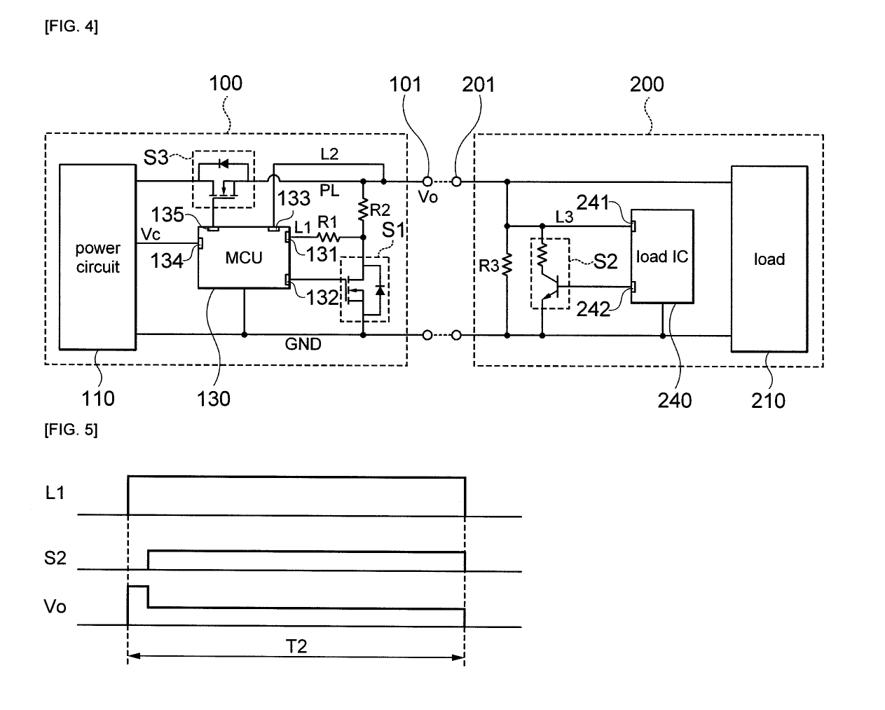

FIG. 4 is an implementation circuit diagram of the system for supplying power in accordance with the present invention. An MCU 130 of FIG. 4 may have functions of the power connection signal generating unit 121 and the load information detecting unit 122 of the above-described FIG. 2, and a load IC 240 of FIG. 4 may have functions of the power connection recognizing unit 221 and the load information signal generating unit 222 of the above-described FIG. 2.

Referring to FIG. 4, an implementation embodiment of the system for supplying power in accordance with the present invention may include a power device 100, which consists of a power circuit 110, a first switching element S1, and an MCU 130, and a load device 200, which consists of a load 210, a second switching element S2, and a load IC 240.

In addition, the load device 200 may further include a resistor R3 connected between a line L3 and a ground line GND, and the power device 100 may further include a third switching element S3 connected between the power circuit 110 and an output terminal 101 of the power device 100 to control output power of the power circuit 110 according to a signal of the MCU 130.

The power circuit 110 outputs power with required voltage and current of the load 210, and the load 210 receives the output power of the power circuit 110 through a power line PL. That is, the power circuit 110 and the load 210 are connected through the power line PL and the ground line GND to enable input and output of power.

The MCU 130 may include a first terminal 131 which transmits an output voltage through a line L1 connected to the power line PL, a second terminal 132 which outputs a signal for controlling on/off operations of the first switching element S1, and a third terminal 133 which senses an output voltage signal Vo through a line L2 connected to the power line PL.

In addition, the MCU 130 may further include a fourth terminal 134 which outputs a control signal Vc to the power circuit 110 and a fifth terminal 135 which outputs a signal for controlling on/off operations of the third switching element S3.

The load IC 240 includes a first terminal 241 which senses the output voltage signal Vo through the line L3 connected to the power line PL and a second terminal 242 which outputs a signal for controlling on/off operations of the second switching element S2.

The first switching element S1 is connected between the line L1 and the ground line GND and converts a waveform of the output voltage, which is transmitted through the line L1, according to the on/off signals of the MCU 130 output from the second terminal 132.

And, the second switching element S2 is connected between the line L3 and the ground line GND and converts the waveform of the output voltage, which is transmitted through the line L1, according to the on/off signals of the load IC 240 output from the second terminal 242.

An operation principle of the implementation embodiment of the system for supplying power in accordance with the present invention configured as above is as follows.

In an initial operation, the MCU 130 outputs the off signal to the second switching element S2 through the fifth terminal 135 to interrupt the output power of the power circuit 110 from being transmitted to the load 210.

When the load device 200 is connected to the power device 100, the output voltage transmitted through the first terminal 131 of the MCU 130 is dropped below a certain level by resistors R1 and R2 connected in series between the first terminal 131 of the MCU 130 and the output terminal 101 of the power device 100 and the resistor R3 provided inside the load device 200. The MCU 130 senses connection of the load device 200 by sensing the output voltage, which is dropped below a certain level, through the line L2 connected to the power line PL.

The MCU 130 outputs the on/off signals to the first switching element S1 through the second terminal 132 according to a preset code for a predetermined time T1 when recognizing the connection of the load device 200. Accordingly, the output voltage transmitted through the line L1 is consumed in a predetermined pattern by the on/off operations of the first switching element S1, and an output voltage signal Vo appearing in the output terminal 101 is converted into a square wave with a specific frequency or duty ratio.

The output voltage signal Vo converted like this is transmitted to an input terminal 210 of the load device 200 from the output terminal 101 of the power device 100 through the power line PL. Then, the load IC 240 senses the output voltage signal Vo through the line L3 connected to the first terminal 241 and recognizes connection of the power device 100 by checking whether the input square wave type output voltage signal Vo has a predetermined specific frequency or duty ratio.

When the load IC 240 recognizes the connection of the power device 100, the load IC 240, for example, as in FIG. 5, outputs a signal in the range (that is, linear region of switching element) of being capable of adjusting a current flow to the second switching element S2 through the second terminal 242 according to the preset code for a predetermined time T2. Accordingly, the output voltage transmitted through the line L1 is uniformly consumed by the operation of the second switching element S2, and the output voltage signal Vo appearing in the output terminal 101 is converted into a direct current of a specific level.

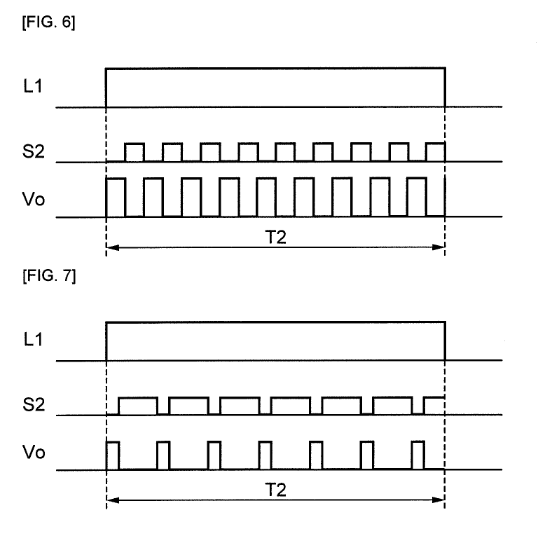

In another way, as in FIG. 6, when the load IC 240 outputs the on/off signals of a specific frequency to the second switching element S2 for the predetermined time T2, the output voltage signal Vo appearing in the output terminal 101 is converted into a square wave with a specific frequency.

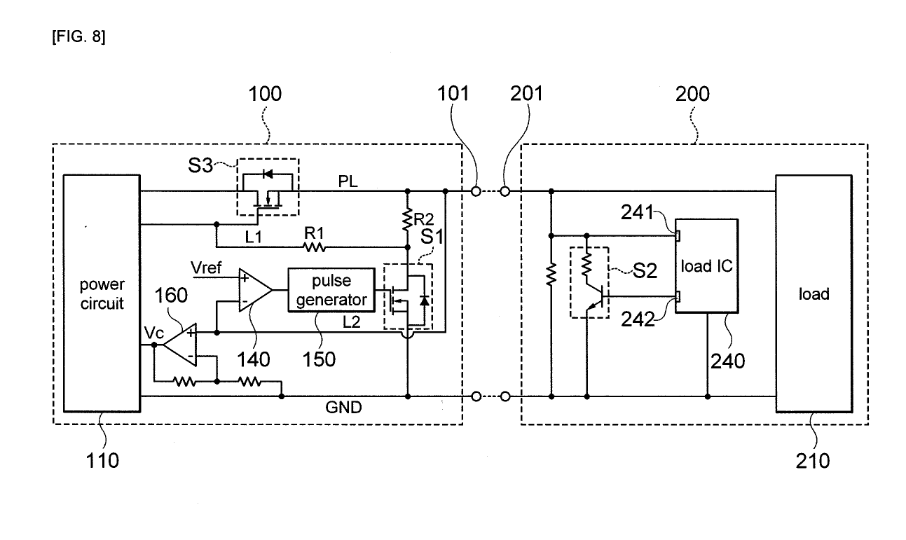

In another way, as in FIG. 7, when the load IC 240 outputs the on/off signals to the second switching element S2 according to a specific duty ratio for the predetermined time T2, the output voltage signal Vo appearing in the output terminal 101 is converted into a square wave with a specific duty ratio.

The output voltage signal Vo converted like this is sensed through the line L2 connected to the power line PL, and the MCU 130 detects information of the load 210 corresponding to the specific level, or the specific frequency or duty ratio of the sensed output voltage signal Vo, that is, voltage and current values required for operation of the load 210.

The power circuit 110 outputs power with voltage and current suitable for the currently connected load device 200 through the power line PL according to the control signal Vc input from the MCU 130. At this time, the MCU 130 outputs the on signal to the third switching element S3 through the fifth terminal 135 to connect the power circuit 110 and the load 210.

The MCU 130 can be implemented as a specific logic as below according to the form of load information signals of FIGS. 5 to 7.

FIG. 8 is a detailed circuit diagram of the system for supplying power implemented in the direct current type output voltage signal Vo with a specific level. At this time, the MCU 130 of FIG. 4 may be implemented with a comparator 140, a pulse generator 150, and an OP amplifier 160 of FIG. 8.

The comparator 140 recognizes the connection of the load device 200 by comparing the output voltage input through an inverting terminal connected to the line L2 and a reference signal Vref input through a non-inverting terminal.

The pulse generator 150 converts the waveform of the output voltage signal Vo by outputting on/off signals to the first switching element S1 according to an output signal of the comparator 140 to consume the output voltage transmitted through the line L1 in a predetermined pattern.

The OP amplifier 160 performs a function of scaling the output voltage signal Vo according to input conditions of the power circuit 110. For example, assuming that an input voltage range of the power circuit 110 is 0 to 3V and a voltage range of the output voltage signal Vo is 0 to 5V, when a voltage of 5V is input to the power circuit 110, the power circuit 110 may be damaged. Further, although a voltage of 3V is input, the power circuit 110 recognizes it as a maximum input range, but since the voltage of 3V corresponds to a medium voltage level, not the maximum input range, the information of the load device 200 may be erroneously transmitted. Therefore, the OP amplifier 160 proportionally adjusts the output voltage signal Vo in the range of 0 to 5V to 0 to 3V which is the input voltage range of the power circuit 110. Although the voltage of the output voltage signal Vo is scaled low in the above example, on the contrary, it may be scaled high.

And, the OP amplifier 160 performs a function of amplifying the output voltage signal Vo. For example, when the current of the output voltage signal Vo is very reduced while the voltage level thereof is constant due to any circuit problem or unexpected reasons, if input impedance of the power circuit 110 is low, the signal may not be transmitted well but attenuated. In this case, the OP amplifier 160 with high input impedance can amplify the attenuated output voltage signal Vo.

The OP amplifier 160 with these functions detects the information of the load 210 through a feedback signal input to the inverting terminal and the output voltage signal Vo of a specific level input to the non-inverting terminal to output the information of the load 210 to the power circuit 110.

The power circuit 110 outputs power corresponding to the output voltage signal Vo of a specific level, that is, power with voltage and current suitable for the load device 200, to the load 210 according to a control signal Vc input from the OP amplifier 160.

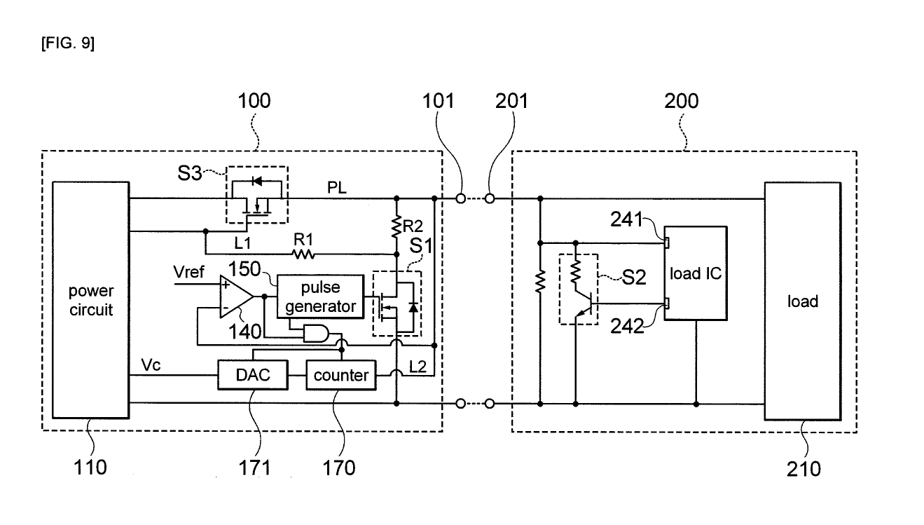

FIG. 9 is a detailed circuit diagram of the system for supplying power implemented in the square wave type output voltage signal Vo with a specific frequency. At this time, the MCU 130 may be implemented with a comparator 140, a pulse generator 150, a counter 170, and a digital-to-analog converter (DAC) 171.

The comparator 140 recognizes the connection of the load device 200 by comparing the output voltage input through the inverting terminal connected to the line L2 and the reference signal Vref input through the non-inverting terminal.

The pulse generator 150 converts the waveform of the output voltage signal Vo by outputting on/off signals to the first switching element S1 according to an output signal of the comparator 140 to consume the output voltage transmitted through the line L1 in a predetermined pattern.

And, the counter 170 counts the number of pulses included in the output voltage signal Vo sensed through the line L2 for the predetermined time T2 to output the number of pluses to the DAC. Here, the number of pulses, that is, the on-time number of the output voltage signal Vo included in the predetermined time T2, has different values according to the frequency.

The DAC 171 converts an output signal of the counter 170 into a continuous signal that can be recognized by the power circuit 110 to output the converted signal to the power circuit 110, and the power circuit 110 outputs power corresponding to the output voltage signal Vo of a specific level to the load 210 according to a control signal Vc of the counter 170.

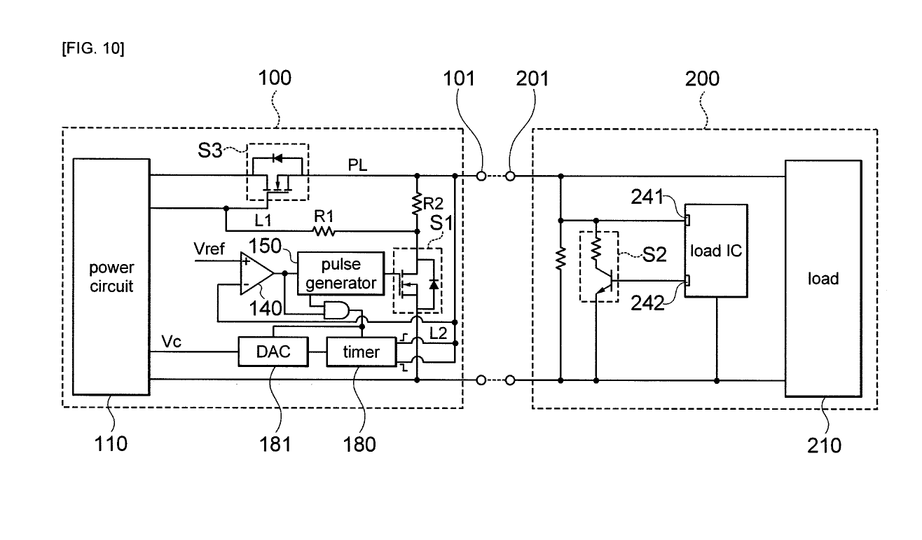

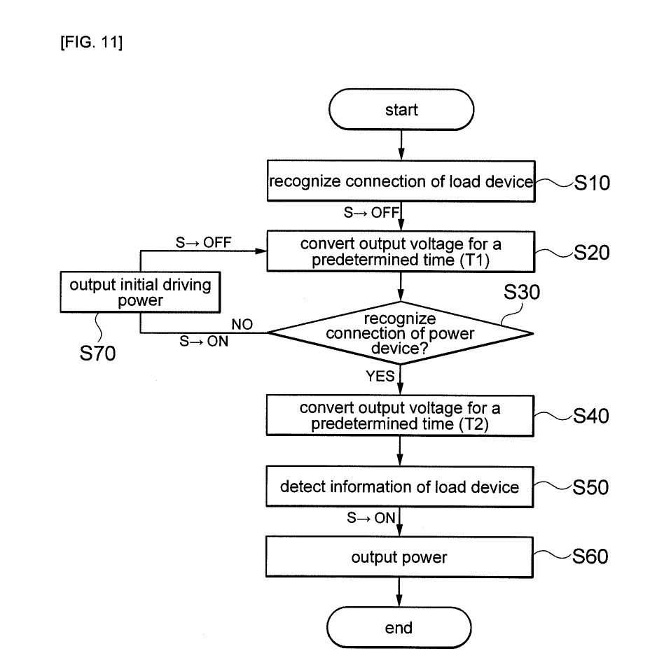

FIG. 10 is a detailed circuit diagram of the system for supplying power implemented in the square wave type output voltage signal Vo with a specific duty ratio. At this time, the MCU 130 may be implemented with a comparator 140, a pulse generator 150, a timer 180, and a DAC 180.

The comparator 140 recognizes the connection of the load device 200 by comparing the output voltage input through the inverting terminal connected to the line L2 and the reference signal Vref input through the non-inverting terminal.

The pulse generator 150 converts the waveform of the output voltage signal Vo by outputting on/off signals to the first switching element S1 according to an output signal of the comparator 140 to consume the output voltage transmitted through the line L1 in a predetermined pattern.

And, the timer 180 senses the duty ratio of the output voltage signal Vo sensed through the line L2 for the predetermined time T2 to output it to the DAC 171. The timer 180 measures the duty ratio of the output voltage signal Vo by starting operation when a rising edge occurs and stopping operation when a falling edge occurs.

The DAC 171 converts an output signal of the counter 170 into a continuous signal that can be recognized by the power circuit 110 to output the converted signal to the power circuit 110, and the power circuit 110 outputs power corresponding to the output voltage signal Vo of a specific level to the load 210 according to a control signal Vc of the timer 180.

FIG. 11 is a flowchart of a method for supplying power in accordance with the present invention. A method for supplying power in accordance with the present invention will be described with reference to FIG. 11.

The method for supplying power in accordance with the present invention, which is described below, uses the above-described system for supplying power of FIG. 2 but is not limited thereto and can use the systems for supplying power of FIG. 4 and FIGS. 8 to 10, which operate equally to FIG. 2. Further, since a method performed in each step of the method for supplying power in accordance with the present invention is the same as that performed in the above-described system for supplying power in accordance with the present invention, repeated description will be omitted.

Referring to FIG. 11, the system for supplying power in accordance with the present invention, first, performs the step of recognizing connection of a load device 200 by a power device 100 when the load device 200 is connected to the power device 100 (S10).

When the power device 100 recognizes the connection of the load device 200, a switching element S is turned off to prevent output power of the power circuit 110 from being transmitted to a load 210.

Next, the step of converting a waveform of an output voltage signal Vo for a predetermined time T1 by a power connection signal generating unit 121 is performed (S20), and the converted output voltage signal Vo is transmitted to a power connection recognizing unit 221.

Next, the step of determining whether the power connection recognizing unit 221 recognizes connection of the power device 100 is performed (S30).

It is possible to determine by whether the output voltage signal Vo is converted by a load information signal generating unit 222 for a predetermined time T2. If the output voltage signal Vo sensed by an output terminal 101 for the predetermined time T2 is not any one form of FIGS. 5 to 7, it is possible to determine that the load device 200 is completely discharged and thus cannot recognize the connection of the power device 100.

In this case, the power circuit 110 outputs power of a minimum voltage level required for initial driving of the load device 200 for a specific time (S70), and the step of converting the waveform of the output voltage signal Vo for the predetermined time T1 is performed again. Here, the minimum voltage level means a voltage level that can charge energy in a battery (not shown in the drawing) provided inside the load device 200 without damaging the load device 200, and the specific time means the time for which initial driving power can be stored in the battery.

At this time, in order to transmit the initial driving power to the load device 200, an output control unit 120 outputs an on signal to the switching element S and outputs an off signal again when the initial driving voltage is charged.

When the load device 200 recognizes the connection of the power device 100 in the step S30, the step of converting the waveform of the output voltage signal Vo for a predetermined time T2 by the load information signal generating unit 222 is performed (S40), and the converted output voltage signal Vo is transmitted to a load information detecting unit 122.

Next, the load information detecting unit 122 detects information of the load device 200 through the output voltage signal Vo converted by the load information signal generating unit 222 (S50). At this time, when the predetermined time T1 and T2 passes, the output control signal 120 outputs the on signal to the switching element S to transmit the output power of the power circuit 110 to the load 210.

Finally, when the load information signal generating unit 222 detects the information of the load device 200, the power circuit 110 outputs power with required voltage and current of the load 210 according to a control signal Vc received from the load information signal generating unit 222.

According to the system and the method for supplying power in accordance with the present invention, since it is possible to enable mutual recognition between the power device and the load device by converting the waveform of the voltage output from the power device, there is no possibility of erroneous recognition of the devices.

Further, since the converted output voltage signal is transmitted to each device through the power line, there is no need for installation of a separate line, thus being excellent in price competitiveness.

Further, unlike a conventional technology of transmitting a signal through a communication line, since there is no obstacle to signal transmission, it is possible to accurately recognize the devices.

Further, since each load device is recognized through the output voltage signal of a predetermined pattern, it is possible to be applied to a plurality of load devices using one power device, thus being advantageous in terms of expandability.

Further, it is possible to more accurately identify a plurality of load devices compared to a conventional technology of identifying a plurality of load devices using impedance.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A system for supplying power comprising a load device and a power device for supplying power to the load device, wherein the power device comprises an output control unit and a power circuit for outputting power with required voltage and current of the load device, and the load device comprises an input control unit and a load for receiving the power from the power circuit, wherein the output control unit comprises:
a power connection signal generating unit for converting a waveform of an output voltage signal Vo to allow the load device to recognize connection of the power device; and
a load information detecting unit for detecting information of the load device through the waveform of the output voltage signal Vo converted by the input control unit, and the input control unit comprises:
a power connection recognizing unit for recognizing the connection of the power device through the waveform of the output voltage signal Vo converted by the output control unit; and
a load information signal generating unit for converting the waveform of the output voltage signal Vo to include the information of the load device.

2. The system for supplying power according to claim 1, wherein the power connection signal generating unit or the load information signal generating unit transmits the converted output voltage signal Vo through a power line PL, and the power connection recognizing unit or the load information detecting unit receives the converted output voltage signal Vo through the power line PL.

3. The system for supplying power according to claim 1, wherein the load information detecting unit outputs a control signal Vc to the power circuit to output power with required voltage and current of the load.

4. The system for supplying power according to claim 1, wherein the information of the load device comprises voltage and current values required for operation of the load.

5. The system for supplying power according to claim 1, wherein the power connection signal generating unit converts the output voltage signal Vo into a square wave with a specific frequency or duty ratio for a predetermined time T1.

6. The system for supplying power according to claim 1, wherein the load information signal generating unit converts the output voltage signal Vo into a square wave with a specific frequency or duty ratio or a direct current of a specific level for a predetermined time T2.

7. The system for supplying power according to claim 1, wherein the power device further comprises:
a switching element connected between the power circuit and an output terminal of the power device to control output power of the power circuit according to a signal of the output control unit.

8. The system for supplying power according to claim 7, wherein the output control unit outputs an off signal to the switching element for the predetermined time T1 and T2 and outputs an on signal after the predetermined time T1 and T2.

9. The system for supplying power according to claim 1, wherein the load device further comprises:
a load recognizing impedance connected between the power line PL and a ground line GND.

10. The system for supplying power according to claim 1, further comprising:
a switching element provided inside the load to prevent the output voltage signal Vo converted by the power connection signal generating unit or the load information signal generating unit from being transmitted to the load.

11. A system for supplying power comprising a load device and a power device for supplying power to the load device, wherein the power device comprises:
a power circuit for outputting power with required voltage and current of the load device;
a microcontroller unit (MCU) comprising a first terminal for transmitting an output voltage through a line L1 connected to a power line PL, a second terminal for outputting a signal for controlling on/off operations of a first switching element S1, and a third terminal for sensing an output voltage signal Vo through a line L2 connected to the power line L2; and
the first switching element connected between the line L1 and a ground line GND to convert a waveform of the output voltage signal Vo, and the load device comprises:
a load for receiving the power from the power circuit;
a load IC comprising a first terminal for sensing the output voltage signal Vo through a line L3 connected to the power line PL and a second terminal for outputting a signal for controlling on/off operations of a second switching element S2; and
the second switching element connected between the line L3 and the ground line GND to convert the waveform of the output voltage signal Vo.

12. The system for supplying power according to claim 11, wherein the MCU detects information of the load device according to the waveform of the output voltage signal Vo sensed through the line L2 and outputs on/off signals to the first switching element to allow the load device to recognize connection of the power device.

13. The system for supplying power according to claim 11, wherein the load IC recognizes the connection of the power device through the waveform of the output voltage signal Vo sensed through the line L3 and outputs on/off signals to the second switching element to include the information of the load device.

14. The system for supplying power according to claim 11, wherein the MCU further comprises a fourth terminal for outputting a control signal Vc to the power circuit.

15. The system for supplying power according to claim 11, wherein the MCU outputs the on/off signals to the first switching element for a predetermined time T1 to convert the output voltage signal Vo, which is transmitted through the line L1, into a square wave with a specific frequency or duty ratio.

16. The system for supplying power according to claim 11, wherein the load IC outputs the on/off signals to the second switching element for a predetermined time T2 to convert the output voltage signal Vo, which is transmitted through the line L1, into a square wave with a specific frequency or duty ratio or a direct current of a specific level.

17. The system for supplying power according to claim 11, wherein the power device further comprises:
a third switching element connected between the power circuit and an output terminal of the power device to control output power of the power circuit according to a signal of the MCU.

18. The system for supplying power according to claim 17, wherein the MCU further comprises:
a fifth terminal for outputting an off signal to the third switching element for the predetermined time T1 and T2 and outputting an on signal after the predetermined time T1 and T2.

19. The system for supplying power according to claim 11, wherein the load device further comprises:
a resistor R3 connected between the line L3 and the ground line GND.

20. The system for supplying power according to claim 19, wherein the MCU recognizes connection of the load device by sensing a drop of the output voltage through the line L3 when the output voltage, which is transmitted through the first terminal of the MCU is dropped below a certain level by the resistor R3.

21. The system for supplying power according to claim 11, wherein the MCU is implemented with:
a comparator for comparing the output voltage input through an inverting terminal connected to the line L2 and a reference voltage Vref input through a non-inverting terminal to recognize the connection of the load device;
a pulse generator for outputting the on/off signals to the first switching element S1 according to an output signal of the comparator to convert the waveform of the output voltage signal Vo; and
an OP amplifier for detecting the information of the load through a feedback signal input to the inverting terminal and the output voltage signal Vo of a specific level input to the non-inverting terminal.

22. The system for supplying power according to claim 11, wherein the MCU is implemented with:
a comparator for comparing the output voltage input through an inverting terminal connected to the line L2 and a reference voltage Vref input through a non-inverting terminal to recognize the connection of the load device;
a pulse generator for outputting the on/off signals to the first switching element S1 according to an output signal of the comparator to convert the waveform of the output voltage signal Vo;
a counter for counting the number of pulses included in the output voltage signal Vo sensed through the line L2 for the predetermined time T2; and
a digital-to-analog converter (DAC) for converting an output signal of the counter into a continuous signal that can be recognized by the power circuit.

23. The system for supplying power according to claim 11, wherein the MCU is implemented with:
a comparator for comparing the output voltage input through an inverting terminal connected to the line L2 and a reference voltage Vref input through a non-inverting terminal to recognize the connection of the load device;
a pulse generator for outputting the on/off signals to the first switching element S1 according to an output signal of the comparator to convert the waveform of the output voltage signal Vo;
a timer for measuring a duty ratio of the output voltage signal Vo sensed through the line L2 for the predetermined time T2; and
a DAC for converting an output signal of the timer into a continuous signal that can be recognized by the power circuit.

24. A method for supplying power using a system for supplying power comprising a power device consisting of a power circuit, a power connection signal generating unit, and a load information detecting unit and a load device consisting of a load, a power connection recognizing unit, and a load information signal generating unit, comprising:
(a) recognizing connection of the load device by the power device when the load device is connected to the power device;
(b) converting a waveform of an output voltage signal Vo for a predetermined time T1 by the power connection signal generating unit;
(c) determining whether the power connection recognizing unit recognizes connection of the power device;
(d) converting the waveform of the output voltage signal Vo for a predetermined time T2 by the load information signal generating unit;
(e) detecting information of the load device through the converted output voltage signal Vo by the load information detecting unit; and
(f) outputting power suitable for the load according to a control signal Vc by the power circuit.

25. The method for supplying power according to claim 24, wherein in the step (a), when the power device recognizes the connection of the load device, a switching element connected between the power circuit and the load is turned off and then turned on after the predetermined time T1 and T2.

26. The method for supplying power according to claim 25, wherein in the step (c), when it is determined that the power connection recognizing unit does not recognize the connection of the power device, the power circuit outputs initial driving power of the load device and the flow branches to the step (b).

27. The method for supplying power according to claim 26, wherein the switching element connected between the power circuit and the load is turned on before the output of the initial driving power and turned off after the output of the initial driving power.
